(19) United States
(12) Patent Application Publication
(10) Pub. No.: US 2015/0368544 A1
(43) Pub. Date: Dec. 24, 2015

(54) METHODS OF INHIBITING SALT PRECIPITATION AND CORROSION

(71) Applicant: SCHLUMBERGER NORGE AS, Stavanger (NO)

(72) Inventors: HANS KLAS JOAKIM ANGMAN, HAFSLUNDSOY (NO); AIMAN KAMARAZUMAN, PORSGRUNN (NO); IAN HOWARD GILBERT, PORSGRUNN (NO)

(21) Appl. No.: 14/312,761

(22) Filed: Jun. 24, 2014

(51) Int. Cl. C09K 8/52; E21B 43/16; C02F 1/68; C09K 8/54; C09K 8/035

(52) U.S. Cl. CPC C09K 8/52; C09K 8/54; C09K 8/035; C02F 1/68; E21B 43/16; C09K 2208/22; C02F 2101/12

(57) ABSTRACT

Inhibiting precipitation of salt from an aqueous solution by providing an aqueous solution of salt dissolved therein, and contacting the aqueous solution with an amount of an organic dinitrile compound at a concentration sufficient to inhibit precipitation of crystallized salt from the aqueous solution under a set of conditions. The method of may be useful in a subterranean formation drilling operation, a subterranean formation treatment operation or a squeeze treatment. The organic dinitrile compound may be present in the aqueous solution at less than about 2000 ppm, or an amount greater than about 100 ppm. In some embodiments, the organic dinitrile compound is admixed with a corrosion inhibitor.

### FIELD

Embodiments disclosed herein relate generally to methods of inhibiting the deposition and/or crystallization of salt. More specifically, embodiments disclosed herein relate to inhibiting the deposition or crystallization of particular sodium chloride salts from brine solutions. Other embodiments disclosed herein relate to methods of inhibiting corrosion of metal surfaces in an industrial or petroleum production related operation.

### BACKGROUND

The statements in this section merely provide background information related to the present disclosure and may not constitute prior art.

Aqueous streams are solutions which often contain dissolved salt which may precipitate in a number of industrial processes. Such aqueous streams are often referred to as brine, which are solutions essentially saturated with various salts. Brines may include sodium chloride and chlorides of potassium, calcium, and magnesium, along with smaller quantities of salts comprising barium, strontium, iron and lead, all of which are collectively referred to herein merely as salt.

Oil and gas reservoirs often contain high salinity brines in the form of connate waters contained within porous rock formations. These brines are produced along with hydrocarbon liquids and gasses. Such brines may cause production problems when they precipitate solid salt materials that can block pores and accumulate in and on pipes and other production equipment. The relative amounts of the salts vary with the mineralogy of the formation rocks that the connate waters have contacted. These brines may also be saturated and/or supersaturated at temperatures above surface temperatures. As brines are brought to the surface, the cooling of these brines and/or the evaporation of water from these brines as a result of oilfield production operations can cause the dissolved salts to crystallize from solution and deposit as solids. The precipitation of salts from these aqueous streams may reduce production of hydrocarbons to the point where remedial action is required, usually involving the re-dissolution of salt using fresh water or low salinity brine. Remedial actions thus require production operations to be limited or even to stop, and often are conducted at short regular intervals on the order of days or even hours depending on the location of the well and/or other variables.

In typical applications, the concentrated brines in underground strata are saturated solutions at elevated temperatures, i.e. in the neighborhood of 90 to 300 degrees Fahrenheit. The temperature of the brine is reduced as it moves toward the earth's surface in the petroleum recovery process. As the temperature falls, the dissolved salts of the brine may precipitate out of solution, in the form of crystals on the inner surface of the well bore and associated piping, pumps, rods, and the like. It is not unusual in certain geographic areas for salt deposits to interfere with pump operations or to completely block the flow of oil and brine within a relatively short time, which may lead to a given well becoming an economic failure due to the high cost of “down time” for cleaning and removing the solid deposits. Sodium chloride is a common precipitated salt which deposits from brines. In addition to oil field applications, brines are also used as heat transfer mediums, in geothermal wells, and numerous other uses. Regardless of the use, when brines saturated at a particular temperature subsequently cool, salt precipitation occurs.

Accordingly, the inhibition of salt from aqueous streams, especially from brine solutions encountered during oil and gas production, presents a challenge, and a continuing need exists for salt inhibitors which are effective at inhibiting salt formation at relatively low concentrations in the aqueous stream.

### SUMMARY

Some aspects of the disclosure include methods of inhibiting precipitation of salt from an aqueous solution by providing an aqueous solution comprising at least one salt at least partially dissolved therein, and contacting the aqueous solution with an amount of an organic dinitrile compound at a concentration sufficient to inhibit precipitation of crystallized salt from the aqueous solution under a set of conditions. The organic dinitrile compound is selected from the group consisting of organic dinitrile compounds having the chemical formula:

NC—R—CN

where R is an alkane, alkene, alkyne, aromatic group, or any mixture thereof. In some instances the organic dinitrile compound is an organic dinitrile compound, and may be selected from the group consisting of dinitrile compounds having the chemical formula:

NC—CₘHₙ—CN

where m is an integer from 2 to 10 and n is an integer from 4 to 20. The method may be useful in a subterranean formation drilling operation, a subterranean formation treatment operation or a squeeze treatment. In some instances, the organic dinitrile compound is present in the aqueous solution at less than about 2000 ppm, or an amount greater than about 100 ppm. In some embodiments, the organic dinitrile compound is admixed with a corrosion inhibitor.

Some other aspects include compositions including an aqueous salt solution and an organic dinitrile compound selected from the group consisting of dinitrile compounds having the chemical formula:

NC—R—CN

where R is an alkane, alkene, alkyne, aromatic group, or any mixture thereof, and wherein the concentration of the salt present in the aqueous solution is higher than the saturation concentration of the salt in the aqueous solution in the absence of the dinitrile compound. In some cases, the organic dinitrile compound is an alkane dinitrile compound, which may have the chemical formula:

NC—CₘHₙ—CN

where m is an integer from 2 to 10 and n is an integer from 4 to 20. The organic dinitrile compound may be present in the aqueous solution at less than about 2000 ppm, or greater than about 100 ppm. In some instances, the organic dinitrile compound is admixed with a corrosion inhibitor.

Other aspects of the disclosure include methods of enhancing the adsorption of a salt inhibitor onto a wellbore region, by preconditioning the wellbore region, and then emplacing the salt inhibitor into the wellbore region, where the salt inhibitor is selected from the group consisting of organic dinitrile compounds having the chemical formula:

NC—R—CN

where R is an alkane, alkene, alkyne, aromatic group, or any mixture thereof, and then shutting in the well for a period of time sufficient to at least initiate adsorption of the salt inhibitor onto the wellbore region. Some embodiments including preconditioning the wellbore region with an acidic solution, such as, but not limited to, 5-20% by volume hydrochloric acid in a chloride brine. Other embodiments include preconditioning the wellbore region with an alkaline solution, such as, but not limited to, a 5-50% by volume ammonium hydroxide solution in a chloride brine. The methods may further include shutting in the wellbore region after the preconditioning stage for a period of time sufficient to initiate the preconditioning of the wellbore region. Nonlimiting examples of such periods include the range of about 0.5 hours to about 4.0 hours, the range of about 0.5 hours to about 12.0 hours, and the like. Embodiments may further include flowing a production of the well back to the surface, and monitoring a salt inhibitor residue from the well. Also, the organic dinitrile compound may be admixed with a corrosion inhibitor.

Yet, other aspects include methods of inhibiting corrosion from a salt in an aqueous solution by providing an aqueous solution comprising at least one salt at least partially dissolved therein, and contacting the aqueous solution with an amount of an admixture of organic dinitrile compound and corrosion inhibitor sufficient to inhibit corrosion by the salt from the aqueous solution. The methods may be used in a subterranean formation drilling operation, a subterranean formation treatment operation, or a squeeze treatment.

Another aspect of the disclosure includes a method of inhibiting gas hydrate formation by providing a petroleum stream comprising gas, and contacting the stream with an amount of an organic dinitrile compound.

Other illustrative variations within the scope of the disclosure will become apparent from the detailed description provided hereinafter. It should be understood that the detailed description and specific examples, while disclosing optional variations, are intended for purposes of illustration only and are not intended to limit the scope of the present disclosure.

### DESCRIPTION

The following description of the variations is merely illustrative in nature and is in no way intended to limit the present disclosure, its application, or uses. At the outset, it should be noted that in the development of any such actual embodiment, numerous implementation—specific decisions may be made to achieve the developers specific goals, such as compliance with system related and business related constraints, which will vary from one implementation to another. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended that any and every point within the range, including the end points, is to be considered as having been stated. For example, “a range of from 1 to 10” is to be read as indicating each and every possible value along the continuum between about 1 and about 10. Thus, even if specific data points within the range, or even no data points within the range, are explicitly identified or refer to a few specific, it is to be understood that inventors appreciate and understand that any and all data points within the range are to be considered to have been specified, and that inventors possessed knowledge of the entire range and all points within the range.

As used herein, concentrations may be expressed as ppm (parts per million) and/or by a percentage of the material in the total composition. Unless otherwise stated, all percents express a weight percent (wt %), based on the amount of the material or component at issue in the total composition.

For purposes herein, a material which inhibits salt precipitation may also be referred to as a salt inhibitor. As used herein, “salt inhibitor” refers to a material, which when present in a solution that contains salt at a first temperature (e.g. above 25° C.), prevents at least some of the salt from precipitating from the solution when the solution is cooled to a second temperature (e.g., less than or equal to about 25° C.), relative to an identical solution under identical conditions which does not include the salt inhibitor.

Without wishing to be bound to any particular theory, the salt inhibitors according to the disclosure are thought to effect nucleation of the indigenous salt and/or distort the crystal growth of the salt in the aqueous salt solution (such as a brine), especially when salt may have already started to crystallize and/or i.e., precipitate from the brine, and/or have formed nuclei before contacting the salt inhibitor. As used herein, “nucleation inhibitor” means an agent or a combination of agents that are efficient at blocking crystalline growth sites such that the initial nucleation of the crystals is inhibited. Nucleation inhibitors are extremely useful in preventing the type of salt precipitation problems experienced in industrial and oilfield operations.

As used herein, the terms ‘contact’, ‘contacted’, and ‘contacting’ effectively means any of combining, mixing, injecting, dispersing, diluting, and dissolving one component with another. For example, a salt inhibitor, or fluid containing a salt inhibitor, may be injected into a wellbore and then allowed to mix with an aqueous solution, or aqueous stream, in a subterranean formation.

The salt inhibitors according to the disclosure contact an aqueous solution having at least one salt at least partially dissolved therein. The aqueous solution may be provided from any applicable source, including, but not limited to, aqueous solutions provided from chemical synthesis operations, preparation and refinement feedstocks and food, treatment of seawater, treatment of municipal water, mining operations, oil and gas related operations, and the like. In oil and gas related operations, aqueous salt solutions may be provided from aqueous streams encountered and produced from subterranean sources such as aquifers or water retained in the formation from drilling operations. Aqueous salt solutions may also be provided from drilling brines, acidizing fluids, or fracturing fluids used in preparing a well for product, which are returned to the surface. The salt inhibitor(s) may also be contacted with aqueous solutions by such techniques as continuous or pulsed injection into a wellbore, bullheading, squeeze treatments, adding to mix tanks at the surface, and the like.

In oilfield operations, in some cases, halite precipitation potential is influenced by such factors as temperature, pressure, CO₂ presence, chemical incompatibility, and pH. Increased temperature can increase halite dissolution capacity in an aqueous solution, as can increased pressure. However, chemical incompatibility with other components in the solution, and high pH, can decrease halite dissolution capacity. In operations, shear forces can increase temperature and affect the above factors, as well as cause water evaporation, thus promoting crystallization and precipitation, as well as increasing corrosion potential. Salt inhibitors according to the disclosure may interfere with the salt crystal growth at a very early stage, leaving uncompleted top layers.

According to some embodiments, methods of inhibiting precipitation of salt from an aqueous solution are disclosed. The methods include contacting an aqueous solution having at least one salt at least partially dissolved therein with an amount of an organic dinitrile compound sufficient to inhibit precipitation of crystallized salt from the aqueous solution. The organic dinitrile compound may be a compound having the chemical formula:

NC—R—CN

where R is an alkane, alkylene, alkyne, or aromatic group, or any mixture thereof.

According to the disclosure, alkanes, alkenes, and alkynes include straight chain, branched and cyclic aliphatic groups, of any molecular weight and chemical structure suitable for utility in methods of inhibiting salt precipitation. For example, alkanes include, but are not limited to, methane, ethane, propane, n-butane, n-pentane, n-hexane, n-heptane, n-octane, n-nonane, n-decane, n-undecane, n-dodecane, isobutane, isopentane, neopentane, 2-methylpentane, 3-ethylpentane, 3,3-dimethylhexane, 2,3-dimethylhexane, 4-ethyl-2-methylhexane, cyclopropane, cyclobutane, cyclopentane, cyclohexane, cycloheptane, and the like. Alkenes include hydrocarbon groups containing at least one carbon-carbon double bond. Examples of some suitable alkenes include, but are not limited to, ethylene, propylene, butylene, pentylene, hexylene, and the like. Alkynes include hydrocarbons containing at least one triple carbon-carbon bond, and some examples include, but are not limited to, acetylene, propyne, 1-butyne, 2-butyne, pentyne isoments, heptyne isomers, 1-phenylhepta-1,3,5-triyne, cycloheptyne, and the like. Aromatic groups include chemical compounds that contain conjugated planar ring systems with delocalized pi electron clouds, and illustrative examples include benzene, toluene, xylene, and the like.

The R groups may also include heteroatoms, or any atom that is not carbon or hydrogen. Some examples of heteroatoms include nitrogen, oxygen, sulfur, phosphorus, chlorine, bromine, and iodine.

In some embodiments, the organic dinitrile compound is an alkane dinitrile compound selected from the group including dinitrile compounds having the chemical formula:

NC—CₘHₙ—CN

where m is an integer from 2 to 10 and n is an integer from 4 to 20. In one embodiment, the alkane dinitrile is hexane dinitrile, which has the chemical structure:

NC—C₄H₈—CN

In some embodiments, the salt inhibitor may be mixed with the aqueous salt solution at any suitable concentration. In some embodiments, the salt inhibitor is combined at a concentration of less than or equal to about 2000 ppm (i.e., 0.2 wt %), in others, less than or equal to about 1000 ppm, or less than or equal to about 500 ppm, or even less than or equal to about 250 ppm.

In other embodiments, the instant salt inhibitor may be combined with an aqueous salt solution at a concentration of greater than or equal to about 10 ppm, while in others, greater than or equal to about 50 ppm, or greater than or equal to about 100 ppm, or even greater than or equal to about 250 ppm.

In some cases useful in subterranean formation operations, the aqueous salt solution (e.g. the brine or subterranean aqueous stream), may be contacted with the salt inhibitor, and then subsequently reinjected back into the reservoir. In yet other embodiments, preparing the wellbore region with a pre-flush treatment may result in enhanced adsorption of the salt inhibitor to the wellbore region. It is believed that the adsorption is enhanced by modifying the surface charges of the wellbore region, such that there is more favorable interaction between the salt inhibitor and the wellbore region. As used herein, “preconditioning the wellbore region,” means treating the wellbore region with a pre-flush treatment, such that the surface charges of the wellbore region are modified. Preconditioning the wellbore region can be achieved by pre-flushing acidic or alkaline aqueous solutions into the wellbore region. A pre-flush solution may be injected into the wellbore region prior to injecting the salt inhibitor.

In applications where preconditioning the wellbore region occurs by pre-flushing the wellbore region with an acidic aqueous solution, the acidic aqueous solution may be comprised of acidic aqueous salt solution(s). In an embodiment, the acidic aqueous solution is 5-20% by volume hydrochloric acid in an ammonium chloride solution. Alternatively, preconditioning of the wellbore region may occur by pre-flushing the wellbore region with alkaline aqueous solutions. When the preconditioning occurs by pre-flushing with an alkaline aqueous solution, the alkaline aqueous solution may be comprised of alkaline aqueous salt solution(s). In an embodiment, the alkaline aqueous solution is 5-50% by volume ammonium hydroxide in an ammonium chloride solution.

The preconditioning of the wellbore may be optimized by shutting in the pre-flush solution for a period of time prior to emplacing the salt inhibitor into the wellbore region. In some embodiments, the pre-flush solution may be shut in to the wellbore region from about 0.1 hours to about 10.0 hours. In other embodiments, the pre-flush solution may be shut in to the wellbore region from about 0.5 hours to about 4.0 hours.

Following the preconditioning treatment, the salt inhibitor may be emplaced into the wellbore region and shut in for a period of time. One of skill in the art may appreciate that the shut in time will vary depending upon the particular application. In some embodiments, the salt inhibitor is shut in for a period of time sufficient to initiate adsorption of the salt inhibitor onto the wellbore region. More particularly, the period of time for shutting in the salt inhibitor is in the range of about 0.5 hours to about 20 hours.

In some other embodiments, the salt inhibitor is injected into the well to contact an aqueous solution present in the subterranean formation. This may be performed over a suitable period of time, either continuously or discontinuously. Delivering the salt inhibitor to the aqueous solution including the scaling brine in the wellbore may be achieved by a number of means, including, but not limited to, continuous injection into the wellbore via a “macaroni string” (a narrow-diameter tubing reaching to the perforations), injection into a gas lift system, or slow dissolution of an insoluble inhibitor placed in a rat hole. Another method of delivering the salt inhibitor solution to the scaling brine is an “inhibitor squeeze.”

In an inhibitor squeeze operation, the salt inhibitor in a solution is forced into the formation through the cased wellbore, where the inhibitor then resides on the rock surface, and slowly leaching back into the produced-water phase at or above the minimum concentration to prevent scaling [the minimum inhibitor concentration (MIC)]. It is intended that the released inhibitor protect the tubulars, as well as the near wellbore. In some cases the salt inhibitor adsorbs on the formation rock with sufficient capacity to provide “long-term” protection. It is also desirable that the inhibitor be relatively stable to thermal degradation under downhole conditions and be compatible in the particular brine system. It may also be further desirable that the inhibitor treatment not cause a permeability reduction and reduced production.

The salt inhibitor squeeze treatments can be carried out where the intention is either to adsorb the inhibitor onto the rock by a physico-chemical process (an “adsorption squeeze”), or to precipitate (or phase separate) the inhibitor within the formation pore space onto the rock surfaces (a “precipitation squeeze”).

Although not bound by any particular theory in operation, adsorption of the salt inhibitor may occur through electrostatic and van der Waals interactions between the inhibitor and formation minerals. The interaction may be described by an adsorption isotherm, which is a function of pH, temperature, and mineral substrate and involves cations such as Ca⁺². Treatment lifetimes are generally on the order of from about 1 to about 24 months.

Some squeeze treatment embodiments according to the disclosure include, the following pumping sequence:
An optional initial acid preflush to clean the scale and debris out of the wellbore to “pickle” the tubing;
“Spearhead” package (a demulsifier and/or a surfactant) which increases the water wetness of the formation and/or to improve injectivity;
Dilute salt inhibitor preflush to pushes the spearhead into the formation and, in some cases, cool the near-wellbore region;
Main salt inhibitor treatment injection into the wellbore to ultimately contact the aqueous solution provided in the formation;
Brine overflush to push the main treatment to the desired depth in the subterranean formation away from the wellbore;
Shut-in or soak period (approximately 6 to 24 hours) where the pumping stops and the inhibitor adsorbs or precipitates onto the rock substrate; and
The well is brought back to production.

Another type of embodiment according to the disclosure involves combined treatments which avoid the cost of intervention of high-volume wells due to the large amounts of deferred oil, and even where intervention at remote locations (e.g., offshore platforms and subsea completions) is even costlier. In such cases, the salt inhibitor is placed as part of a scale-removal process, providing both treatments with one setup and intervention. One of these embodiment is the inclusion of the salt inhibitor with an acid stimulation process for dissolving calcite scale.

Yet another dual-treatment embodiment includes of combining the salt inhibitor treatment along with hydraulic fracture stimulation. For example, the salt inhibitor can be injected into the pumped gel/sand mixture to form a sufficiently insoluble and immobile scale-inhibitor material within the proppant pack.

In yet another combined treatment embodiment, the salt inhibitor is impregnated into porous ceramic proppant along with conventional proppant in hydraulic fracture stimulation. Upon production, any water flowing over the surface of the impregnated proppant will contact the salt inhibitor. However, dry oil may not release the salt inhibitor from the proppant. Both of the embodiments described immediately above may also help protect the fracture itself from plugging with scale.

Other embodiments include use of the salt inhibitor as a gas hydrate inhibitor as well. Gas hydrates are crystalline water-based solids physically resembling ice, in which small non-polar molecules (generally gases) or polar molecules with large hydrophobic moieties are trapped inside “cages” of hydrogen bonded water molecules. Gas hydrates can form in pipelines under certain known thermodynamic conditions, which is highly undesirable; because the crystals might agglomerate and plug the line and cause flow assurance failure and damage valves and instrumentation. The results can range from flow reduction to equipment damage. To avoid the formation of gas hydrates, the inhibitor may be injected into the pipeline and petroleum stream to lower the hydrate formation temperature and/or delay their formation.

The organic dinitrile salt inhibitors may further be used in combination with other salt inhibitors. Examples of such other salt inhibitors include, but are not limited to, salts of bromine; salts of alkali metals including phosphates, chlorates, bromates, iodates, ferrocyanides, chlorides and the like; and organic compounds including crown ethers, dicarboxylic acids, tetracarboxylic acids, diphosphoric acids, diphosphonic acids, polyphosphoric acids, phosphates, formamides and the like; and combinations including one or more of the foregoing. Specific compounds found useful include potassium bromate, potassium ferrocyanide, ethylene diamine tetra-acetic acid (EDTA), phosphoric acid, malonic acid, malic acid, potassium iodate, adenosine triphosphate (ATP), adenosine diphosphate (ADP), 5-amino-2,4,6-trioxo-1,3-perhydrodizine-N,N-diacetic acid (uramil-N,N-diacetic acid), polyphosphoric acid (poly PA), 1-hydroxyethlidene-1,1-diphosphonic acid (HEDP), diethylene triamine penta(methylene phosphoric acid) (DTPMP), amino tri(methylene phosphonic acid) (ATMP), pyrophosphoric acid (PPA), methylene diphosphoric acid (MDPA), and combinations thereof. Some additives include uramil N,N-diacetic acid, HEDP, DTPMP, ATMP, PPA, MDPA, the tri-sodium salt of the phosphonic acid known under the trade name “Dequest 2066A, (available from Solutia, Inc., St. Louis, Mo.) and combinations thereof.

In some instances, an acidic material may be added to the composition primarily to reduce the pH thereof. In some of these embodiments, the composition can be a three component system, i.e. corrosion inhibitor, material to react with the corrosion inhibitor to form a precipitate, and an acid different from the material to form the precipitate.

Substantially any acid which will meet the above requirements can be employed. Generally, suitable, but non-limiting, acids are hydrochloric, sulfuric, nitric, sulfamic, citric, acetic, chloroacetic, peracetic, and polyacrylic.

In some embodiments, the salt inhibitor is combined with a corrosion inhibitor providing a binary effect of salt precipitation inhibition and corrosion inhibition. Some nonlimiting examples of such corrosion inhibitors include, organic or ioni compounds that are employed in small concentrations (less than 1 wt. %). They are often categorized as mixed inhibitors as they adsorb on the steel surface and inhibit both anodic and cathodic reactions. Suitable organic molecules inhibitors are polar, based on nitrogen, such as the amines, amides, imidazolines, or quaternary ammonium salts and compounds containing phosphorous, sulfur and oxygen elements. Some suitable organic corrosion inhibiting molecules have a hydrocarbon chain attached to the polar group, the length of which varies (carbon numbers between 12 and 18). The organic corrosion inhibitors may be surface-active agents due to the presence of hydrophilic and hydrophobic moieties within the same molecule. One particularly useful corrosion inhibitor is a mixture of alkyl dimethyl benzyl ammonium chloride with a fatty acid amine condensate and thioglycolic acid in 2-butoxyethanol solvent. Other suitable corrosion inhibitors are compounds readily known to those of skill in the art.

Embodiments may use other additives and chemicals, including but not limited to, materials in addition to those mentioned hereinabove, such as breaker aids, oxygen scavengers, alcohols, antifoaming agents, pH buffers, pH adjusters, fluid-loss additives, bactericides, iron control agents, organic solvents, water control agents and cleanup additives, gas components, and the like, depending on the intended use of the fluid, formation conditions and other parameters. For example, drilling fluids may further comprise surface active agents, other viscosifiers such as polymers or viscoelastic surfactant, filtration control agents such as Gilsonite and modified starches, density increasing agents such as powdered barites or hematite or calcium carbonate, or other wellbore fluid additives.

### EXAMPLES

The following examples serve to describe the general method of reducing salt precipitation from aqueous solutions containing at least one salt at least partially dissolved therein. The examples are illustrative of some of the embodiments of the disclosure. Other embodiments within the scope of the claims herein will be apparent to one skilled in the art from consideration of the description set forth herein. It is intended that the specification, together with the examples, be considered illustrative, with the scope and spirit of the present disclosure being indicated by the claims which follow.

The tests conducted in the following examples illustrated in tables 2 through 5 used a saturated TAGI-MDT brine with the composition shown in table 1. The saturated brine was prepared at room temperature and undissolved salts are filtered using filter paper. 50 mL of the saturated brine was measured and poured into wide-neck bottle. After inhibitor was contacted with the brine, the mixture was placed inside 90° C. oven for four hours and then moved to 50° C. for another four hours before being cooled down at room temperature for one hour, unless otherwise noted in specific tests. Reading of halite precipitation was recorded at the time periods indicated which are elapsed from initial placement in the 90° C. oven.

TABLE 1
TAGI MDT Water Ion Composition

| Ion | Brine Composition, mg/L |
|---|---|
| Chloride | 213305 |
| Barium | 12 |
| Calcium | 19106 |
| Strontium | 220 |
| Magnesium | 14223 |
| Sodium | 89045 |
| Potassium | 2607 |

The test results presented in the table below used the following rating system, unless otherwise indicated:

| Rating Value | Description |
|---|---|
| 0 | Clear, no precipitate |
| 1 | Slight haze, slight |
| | precipitate |
| 2 | Hazy, moderate |
| | precipitate |
| 3 | Cloudy, heavy |
| | precipitate |

The ratings in the below tables also show intermittent ratings between the whole number values. For example, where ‘1−’ is indicated as a rating value, it is meant that the sample showed less than ‘slight haze, slight precipitate’ in the comparative evaluations, but not completely ‘clear, no precipitate’. Where ‘2+’ is indicated, the sample showed more than ‘hazy, moderate precipitate’, but not ‘cloudy, heavy precipitate’.

Salt inhibitors evaluated included those containing an approximately 40% by weight aqueous solution of hexanedintrile with a pH value adjusted with hydrochloric acid to about 9 to 10, and zinc nitrate. Candidates were evaluated versus a TAGI MDT Water blank without any salt inhibitor, and potassium hexacyanoferrate (HCF) in the same concentration as the salt inhibitors evaluated.

Table 2 provides results for a first test conducted according to the above test description. In this test, 2000 ppm of the listed salt inhibitor candidates was added to 50 ml of TAGI MDT water. Versus a blank control sample, salt inhibitor candidates evaluated included HCF, Zinc Nitrate, and hexanedinitrile.

TABLE 2
First Test Results

Salt Inhibitor

| Time, | Temp. | | | | Zinc |
|---|---|---|---|---|---|
| hrs | (° C.) | Blank | HCF | Hexanedintrile | Nitrate |
| 1 | 90 | 1 | 0 | 0 | 1− |
| 2 | 90 | 1 | 1− | 0 | 1− |
| 3.5 | 90 | 1+ | 1+ | 0 | 1 |
| 4.5 | 50 | 2+ | 1+ | 0 | 1 |
| 5.5 | 50 | 3 | 1+ | 1− | 1+ |
| 6.75 | 50 | 3 | 1+ | 2+ | 2+ |

In this first test conducted, the hexanedinitrile salt inhibitor outperformed the other candidates evaluated.

Table 3, below, illustrates results for a second test conducted according to the above test description. In this test, 1000 ppm of the listed salt inhibitors was added to 50 ml of TAGI MDT water. The second test began at a temperature of 90° C. and after the 4 hour readings were made, samples were then cooled to 50° C. and evaluated. Then the last two readings were taken at room temperature.

TABLE 3
Second Test Results

| Time, | Temp, | | | |
|---|---|---|---|---|
| hrs | ° C. | Blank | HCF | Hexanedintrile |
| 1 | 90 | 1−− | 1−− | 0 |
| 2 | | 1−− | 1− | 1−− |
| 4 | | 2 | 1− | 1−− |
| 5 | 50 | 3 | 1− | 1 |
| 6 | | 3 | 1− | 1+ |
| 7 | | 3+ | 1− | 1+ |
| 8 | Room | 3+ | 1− | 2− |
| 8.5 | Temperature | 3+ | 1 | 2− |

Table 4, below, illustrates results for a third test conducted according to the above test description. In this test, 1000 ppm of the listed salt inhibitor candidates, or mixtures of candidates, was added to 50 ml of TAGI MDT water. This evaluation indicated that single salt inhibitor candidates performed slightly better than when used in combination with zinc nitrate.

TABLE 4
Third Test Results

| | | | | | 50/50 |
|---|---|---|---|---|---|
| Time, | Temp. | | | | Hexanedintrile/Zinc |
| HRS | ° C. | Blank | HCF | Hexanedintrile | Nitrate |
| 1.5 | 90 | 0 | 0 | 0 | 0 |
| 2.5 | | 0 | 0 | 0 | 0 |
| 3.5 | | 1 | 0 | 0 | 1−− |
| 4 | 50 | 2 | 1−− | 0 | 1− |
| 5 | | 2+ | 1−− | 1−− | 1 |
| 6 | | 3 | 1−− | 1− | 1 |
| 7 | | 3 | 1− | 1 | 1 |
| 8 | Roam | 3+ | 1 | 2 | 2 |
| | Temperature | | | | |

Table 5 shows results for a fourth test conducted according to the above test description. In this test, 2000 ppm of the listed salt inhibitor candidate, or mixtures of candidates with a corrosion inhibitor (CI), was added to 50 ml of TAGI MDT water. The corrosion inhibitor (CI) was a mixture of alkyl dimethyl benzyl ammonium chloride with a fatty acid amine condensate and thioglycolic acid in 2-butoxyethanol solvent, which was added at 100 ppm. This evaluation showed the hexanedinitrile performed slightly better compared with the combination product. The tests showed hexanedinitrile performed well, as compared with the other salt inhibitor candidates. ‘NC’ indicates that mixture was not compatible in the aqueous solution.

TABLE 5
Fourth Test Results

| Time, | Temp. | | | | |
|---|---|---|---|---|---|
| hrs | ° C. | Blank | HCF | Hexanedintrile | Hexanedintrile/Cl |
| 1.5 | 90 | 1−− | 1−− | 0 | 0 |
| 3 | | 1−− | 1−− | 0 | 0 |
| 4 | | 1− | 1−− | 0 | 0 |
| 5.25 | 50 | 2+ | 1+ | 1− | 1 |
| 6.25 | | 3− | 2− | 2− | 2 |
| 7.25 | Room | 3 | 2− | 2 | 2 |
| | Temperature | | | | |

Table 6 shows results for a fifth evaluation conducted, which was a corrosion inhibition test performed with mixtures of salt inhibitors with corrosion inhibitor (CI), described above. In this evaluation, the effect of the corrosion inhibitor (CI) corrosion rate under static (non-shear) conditions using linear polarization resistance (LPR) was determined. Tests were performed on 100% brine and a mixture of brine and oil, simulating conditions in a line, and performance was evaluated by comparison of corrosion rates before and after addition of inhibitor. The brine used in this evaluation is the same composition as that shown in table 1 above.

The evaluations were conducted using standard kettle equipment. The tests were performed on 100% synthetic brine. The test cell was primed with fluid and sparged with CO₂ for 2 hours prior to logging corrosion rate data. The baseline corrosion rate was established over 2 hours or until stable, then corrosion inhibitor was injected directly to the brine. In this evaluation, the water cut was 100%, CI dosage was 100 ppm, and salt inhibitor dosage was 2000 ppm. The temperature was 90° C., electrode material was carbon steel (C1018), and the test duration was 1 day.

The corrosion rate was monitored until the observed corrosion rate stabilized, and the inhibitor performance established by comparison of the inhibited corrosion rate to the baseline uninhibited corrosion rate. Corrosion rate was measured in units of mpy (mils per year, a mil being a thousandth of an inch).

TABLE 5
Corrosion Test Results

| | | Pre/Start | Inhibited | |
|---|---|---|---|---|
| | | Corrosion Rate | Corrosion | |
| Inhibitor | Dose (ppm) | mpy | Rate mpy | % Protection |
| Cl only | 100 | 233 | 12.0 | 94.8 |
| Cl + | 100 + 2000 | 213 | 6.0 | 97.2 |
| Hexanedinitrile | | | | |

With a dose rate of 100 ppm, the CI provided corrosion protection of 94.8%. However tests with presence of a hexanedinitrile at 2000 ppm showed improved corrosion protection.

While embodiments have been illustrated and described in detail in the foregoing description, the same is to be considered as illustrative and not restrictive in character, it being understood that only some example embodiments have been shown and described and that all changes and modifications that come within the spirit of the inventions are desired to be protected. It should be understood that while the use of certain terms in the description above may indicate that the feature so described may be more desirable or characteristic, embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim.

What is claimed is:

1. A method of inhibiting precipitation of salt from an aqueous solution, the method comprising;
a. providing an aqueous solution comprising at least one salt at least partially dissolved therein; and,
b. contacting the aqueous solution with an amount of an organic dinitrile compound sufficient to inhibit precipitation of crystallized salt from the aqueous solution under a set of conditions, wherein the organic dinitrile compound is selected from the group consisting of organic dinitrile compounds having the chemical formula:
NC—R—CN
where R is an alkane, alkene, alkyne, aromatic group, or any mixture thereof.

2. The method of claim 1 whereby an amount of salt precipitation from the aqueous solution that would otherwise occur from the aqueous solution under the essentially identical conditions is reduced by contacting the aqueous solution with the organic dinitrile compound.

3. The method of claim 1 wherein the organic dinitrile compound is an alkane dinitrile compound.

4. The method of claim 3 wherein the alkane dinitrile compound is selected from the group consisting of dinitrile compounds having the chemical formula:
NC—CₘHₙ—CN
where m is an integer from 2 to 10 and n is an integer from 4 to 20.

5. The method of claim 1 as used in a subterranean formation drilling operation.

6. The method of claim 1 as used in a subterranean formation treatment operation.

7. The method of claim 6 wherein the treatment operation is a squeeze treatment.

8. The method of claim 1, wherein the organic dinitrile compound is present in the aqueous solution at less than about 2000 ppm.

9. The method of claim 1, wherein the organic dinitrile compound is present in the aqueous solution at greater than about 100 ppm.

10. The method of claim 1, wherein the organic dinitrile compound is admixed with a corrosion inhibitor.

11. A composition comprising an aqueous salt solution and an organic dinitrile compound selected from the group consisting of dinitrile compounds having the chemical formula:
NC—R—CN
where R is an alkane, alkene, alkyne, aromatic group, or any mixture thereof;
wherein the concentration of the salt present in the aqueous solution is higher than the saturation concentration of the salt in the aqueous solution in the absence of the dinitrile compound.

12. The composition of claim 11 wherein the organic dinitrile compound is an alkane dinitrile compound.

13. The composition of claim 12 wherein the alkane dinitrile compound is selected from the group consisting of dinitrile compounds having the chemical formula:
NC—CₘHₙ—CN
where m is an integer from 2 to 10 and n is an integer from 4 to 20.

14. The composition of claim 11, wherein the organic dinitrile compound is present in the aqueous solution at less than about 2000 ppm.

15. The composition of claim 14, wherein the organic dinitrile compound is present in the aqueous solution at greater than about 100 ppm.

16. The composition of claim 11, wherein the organic dinitrile compound is admixed with a corrosion inhibitor.

17. A method of enhancing the adsorption of a salt inhibitor onto a wellbore region, the method comprising:
a. preconditioning the wellbore region;
b. emplacing the salt inhibitor into the wellbore region, wherein the salt inhibitor is selected from the group consisting of organic dinitrile compounds having the chemical formula:
NC—R—CN
where R is an alkane, alkene, alkyne, aromatic group, or any mixture thereof; and,
c. shutting in the well for a period of time sufficient to at least initiate adsorption of the salt inhibitor onto the wellbore region.

18. The method of claim 17, wherein the preconditioning the wellbore region includes preconditioning the wellbore region with an acidic solution.

19. The method of claim 18, wherein the acidic solution is a 5-20% by volume hydrochloric acid in a chloride brine.

20. The method of claim 17, wherein the preconditioning the wellbore region includes preconditioning the wellbore region with an alkaline solution.

21. The method of claim 20, wherein the alkaline solution is a 5-50% by volume ammonium hydroxide solution in a chloride brine.

22. The method of claim 17, wherein the preconditioning the wellbore region includes shutting in for a period of time sufficient to precondition the wellbore region.

23. The method of claim 22, wherein the shut in period of time is in the range of about 0.5 hours to about 4.0 hours.

24. The method of claim 17, wherein the adsorption shut in period of time is in the range of about 0.5 hours to about 12.0 hours.

25. The method of claim 17, further comprising flowing a production of the well back to the surface, and monitoring a salt inhibitor residue from the well.

26. The method of claim 17, wherein the organic dinitrile compound is admixed with a corrosion inhibitor.

27. A method of inhibiting corrosion from a salt in an aqueous solution, the method comprising:
a. providing an aqueous solution comprising at least one salt at least partially dissolved therein; and,
b. contacting the aqueous solution with an amount of an admixture of organic dinitrile compound and corrosion inhibitor sufficient to inhibit corrosion by the salt from the aqueous solution, wherein the organic dinitrile compound is selected from the group consisting of organic dinitrile compounds having the chemical formula:
NC—R—CN
where R is an alkane, alkene, alkyne, aromatic group, or any mixture thereof.

28. The method of claim 27 wherein the organic dinitrile compound is an alkane dinitrile compound.

29. The method of claim 28 wherein the alkane dinitrile compound is selected from the group consisting of dinitrile compounds having the chemical formula:
NC—CₘHₙ—CN
where m is an integer from 2 to 10 and n is an integer from 4 to 20.

30. The method of claim 27 as used in a subterranean formation drilling operation.

31. The method of claim 27 as used in a subterranean formation treatment operation.

32. The method of claim 27, wherein the organic dinitrile compound is present in the aqueous solution at less than about 2000 ppm.

33. The method of claim 27, wherein the organic dinitrile compound is present in the aqueous solution at greater than about 100 ppm.

34. A method of inhibiting gas hydrate formation, the method comprising:
a. providing a petroleum stream comprising gas; and,
b. contacting the stream with an amount of an organic dinitrile compound, wherein the organic dinitrile compound is selected from the group consisting of organic dinitrile compounds having the chemical formula:
NC—R—CN
where R is an alkane, alkene, alkyne, aromatic group, or any mixture thereof.
